(19) United States
(12) Patent Application Publication
(10) Pub. No.: US 2013/0117839 A1
(43) Pub. Date: May 9, 2013

(54) METHOD FOR CONTROLLING APPLICATION USAGE ON A MOBILE DEVICE WHILE THE DEVICE IS IN MOTION

(71) Applicants: Steven W. White, Plano, TX (US); Ashok Ramadass, Allen, TX (US)

(72) Inventors: Steven W. White, Plano, TX (US); Ashok Ramadass, Allen, TX (US)

(21) Appl. No.: 13/662,211

(22) Filed: Oct. 26, 2012

Related U.S. Application Data
(60) Provisional application No. 61/628,376, filed on Oct. 31, 2011.

(51) Int. Cl. G06F 21/50

(52) U.S. Cl. CPC G06F 21/50
USPC 726/16

(57) ABSTRACT

The disclosure generally describes computer-implemented methods, software, and systems for controlling access to applications on a device while the device is in motion. One example computer-implemented method includes identifying a request to access an application on a device, determining if the requested application is a motion-restricted application, upon determination that the requested application is a motion-restricted application, identifying a speed of movement associated with the device, and controlling access to the requested application based at least in part on the identified speed of movement of the device.

### CLAIM OF PRIORITY

This application claims priority under 35 USC §119(e) to U.S. Provisional Patent Application Ser. No. 61/628,376, filed on Oct. 26, 2011, the entire contents of which are hereby incorporated by reference.

### BACKGROUND

As mobile devices increase in computing power, the complexity of the applications the devices are capable of running also increases. Current mobile devices allow a user to perform complex tasks such as, for example, taking photos with integrated cameras, submitting these photos to social networking services such as Facebook or Twitter, sending and receiving email, surfing the Internet, playing video games, creating complicated documents and presentations, and many other tasks.

These increasingly complex applications demand greater and greater amounts of attention from the mobile user. Diverting of the user's attention can be dangerous, as mobile devices are often used while the user is driving. For example, a user texting on their mobile device while driving may cause an accident because their attention is not entirely focused on driving. In response, many jurisdictions have instituted restrictions on mobile device use while driving in special areas such as school zones or, in some cases, have prohibited mobile use while driving altogether.

### SUMMARY

The present disclosure generally describes computer-implemented methods, software, and systems for controlling access to applications on a device while the device is in motion. One example computer-implemented method includes identifying a request to access an application on a device, determining if the requested application is a motion-restricted application, upon determination that the requested application is a motion-restricted application, identifying a speed of movement associated with the device, and controlling access to the requested application based at least in part on the identified speed of movement of the device.

While generally described as computer implemented software embodied on tangible media that processes and transforms the respective data, some or all of the aspects may be computer implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for implementing various features of a system capable of controlling application usage on a mobile device while the device is in motion.

FIG. 2 illustrates another example environment for implementing various features of a system capable of controlling application usage on a mobile device while the device is in motion.

FIG. 3 is a flowchart of an example method for controlling application usage on a mobile device while the device is in motion.

FIG. 4 is a flowchart of an example method for determining whether an identified speed of the mobile device necessitates access control.

FIG. 5 is a flowchart of an example method for configuring the motion control access restrictions.

### DETAILED DESCRIPTION

This disclosure generally relates to software, computer systems, and computer-implemented methods for controlling application usage on a mobile device while the device is in motion. Further, the described solution may consult a configuration to determine specific aspects of how to control application usage, such as utilizing mechanisms to restrict access to the applications and a speed threshold for determining whether the device is in motion.

In one instance, the described solution can identify situations in which a user is attempting to make use of an application on a mobile device while driving or performing some other action which requires the user's attention. In such situations, the described solution may restrict access to the application by disabling it entirely, by disabling certain features, or by some other means.

By restricting access to mobile applications, the described solution may ensure that a mobile user's attention is focused on an important task, such as driving, while they are in motion. Further, the solution may allow parents to set such restrictions on their children's phones in order to ensure that the children are not driving, biking, or performing other dangerous travel activities while distracted.

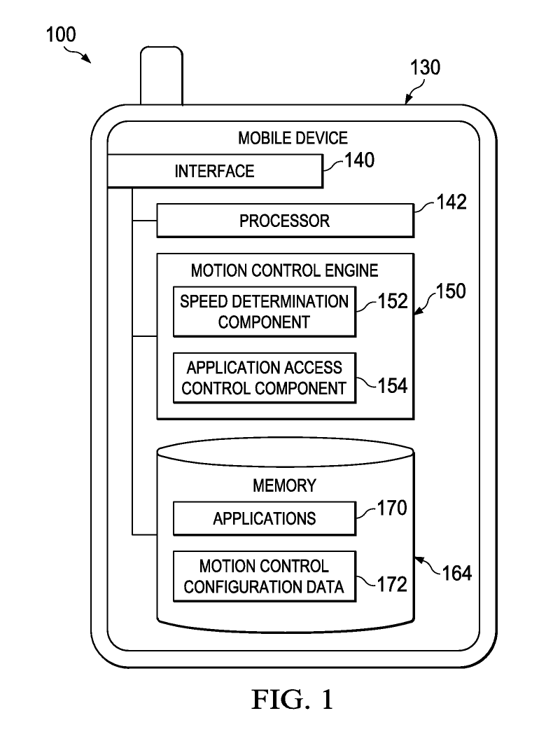

FIG. 1 illustrates an example environment 100 for implementing various features of a system capable of controlling application usage on a mobile device while the device is in motion. The illustrated environment 100 may include, or may be communicably coupled with, a mobile device 130. At a high level, the mobile device 130 is a data processing apparatus capable of being carried by a user. In some implementations, the mobile device 130 may be a mobile telephone such as a smartphone or PDA, a mobile tablet computer such as an iPad™, a laptop computer, a pager, an embedded system inside a larger product such as a vehicle, or any other appropriate device or combination of appropriate devices. In the illustrated implementation the mobile device 130 includes an interface 140, a processor 142, a motion control engine 150, and a memory 164. In some instances, the mobile device 130 and its illustrated components may be separated into multiple components executing at different servers and/or systems. Thus, while illustrated as a single component in the example environment 100 of FIG. 1, alternative implementations may illustrate the mobile device 130 as comprising multiple parts or portions accordingly.

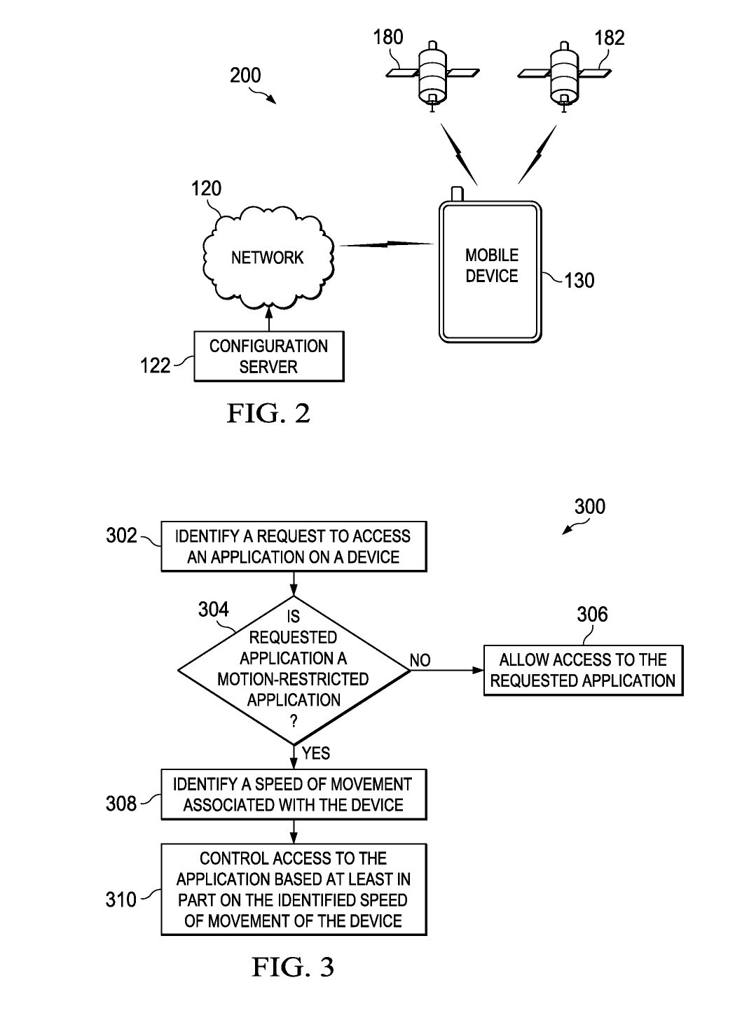

The interface 140 is used by the mobile device 130 to communicate with a network, such as, for example network 120 depicted in FIG. 2. The interface 140 generally comprises logic encoded in software and/or hardware in a suitable combination and operable to communicate with a network. More specifically, the interface 140 may comprise software supporting one or more communication protocols associated with communications such that the network or the interface's hardware is operable to communicate physical signals within and outside of the illustrated environment 100. The interface 140 may further include logic to receive global positioning information from GPS satellites, such as, for example, the satellites 180 and 182 depicted in FIG. 2. In such implementations, the interface 140 may include a GPS transceiver or other dedicated hardware or software specialized for the reception and interpretation of the GPS information.

The interface 140 is also used by the mobile device 130 to communicate with other systems in a client-server, cloud computer, or other distributed environment (including within environment 100) connected to the network 120.

As illustrated in FIG. 1, the mobile device 130 includes a processor 142. Although illustrated as a single processor 142 in the mobile device 130, two or more processors may be used in the mobile device 130 according to particular needs, desires, or particular implementations of environment 100. The processor 142 may be a central processing unit (CPU), an application specific integrated circuit (ASIC), a field-programmable gate array (FPGA), or another suitable component. Generally, the processor 142 executes instructions and manipulates data to perform the operations of the mobile device 130 and, specifically, the functionality associated with controlling application usage on a mobile device while the device is in motion.

The mobile device 130 also includes a motion control engine 150. The motion control engine 150 may be or may include any suitable application(s), program(s), module(s), process(es), or other software that may execute, change, delete, generate, or otherwise manage information associated controlling access to applications based on the motion of the mobile device 130. Specifically, the motion control engine 150 may be used to collect or calculate data representative of the present speed of the mobile device 130, to examine configuration data to determine how to control access to applications based on the present speed of the mobile device 130 in accordance with configuration data, and to control access to the applications of the mobile device 130.

In the depicted implementation, the motion control engine 150 includes a speed determination component 152, and an application access control component 154. The speed determination component 152 may be a hardware or software component that communicates with the GPS satellites 180 and 182 to determine the speed of movement of the mobile device 130. This determination may include determining the position of the mobile device 130, then determining the position of the mobile device 130 a second time. These two positions may then be compared to determine the distance traveled by the mobile device in the time between the two readings. This distance may then be divided by the time between the two readings to compute the speed of movement of the mobile device 130. In other cases, the speed determination component may determine the speed of movement of the mobile device 130 by utilizing multilateration of radio signals from multiple radio towers in a cellular telephone network. In other implementations, the speed determination component 152 includes hardware or software capable of computing the current speed of the mobile device without relying on external data. In other cases, the speed determination component 152 may interface with another system within the mobile device 130 to acquire the speed of the mobile device 130. In still other cases, the speed determination component 152 may acquire the speed of the mobile device 130 by interfacing with systems external to the mobile device 130. For example, in an implementation in which the mobile device 130 is embedded within a vehicle, the speed determination component 152 may acquire the speed of the vehicle, and thus the embedded mobile device, from a speed tracking system associated with the vehicle such as a speedometer.

The application access control component 154 may restrict, prohibit, allow, or otherwise control access to applications, such as applications 170, on the mobile device 130 based on configuration data, such as motion control configuration data 172. The application access control component 154 may be an operating system level software service that controls how a user of the mobile device can interact with an application. In other cases, the application access control component 154 may be an integrated hardware component. In one implementation, the application access control component 154 may disable an application's capability to use one or more subsystems of the mobile device 130. For example, the application access control component 154, in response to a speed of movement reading that is above a threshold, may disable keypad input for an SMS texting application on the mobile device 130. In another example, the application access control component 154 may disable the wireless communication capability of an application such as a web browser or email client. In still another example, the application access control component 154 may disable an application entirely in response to a speed of movement reading that is above the threshold. In another case, the application access control component 154 may disable the mobile device 130 entirely in response to a speed of movement reading that is above the threshold.

Regardless of the particular implementation, “software” may include computer-readable instructions, firmware, wired or programmed hardware, or any combination thereof on a non-transitory medium operable when executed to perform at least the processes and operations described herein. Indeed, each software component may be fully or partially written or described in any appropriate computer language including C, Objective-C, C++, Java™, Visual Basic®, assembler, Perl®, Python, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, each processor 142 executes the corresponding motion control engine 150 stored on the associated mobile device 130. In some instances, a mobile device 130 may be associated with the execution of two or more instances of the motion control engine 150, as well as one or more distributed applications executing across two or more devices associated with mobile device 130.

As illustrated in FIG. 1, the mobile device 130 also includes a memory 164. The memory 164 may be any non-transitory, computer-readable medium or an array of multiple heterogeneous or homogeneous computer-readable media. The illustrated memory 164 includes a plurality of applications 170, and a set of motion control configuration data 172.

The plurality of applications 170 may include any software applications capable of executing on the mobile device 130. In some implementations, the applications 170 may include applications purchased from the Apple® App Store, the Android™ Marketplace, the Amazon® App Store, or from another application store or other source of software applications. In other implementations, the applications 170 may be software applications included by the phone manufacturer or carrier such as a built-in maps application or SMS texting application.

The memory 164 may also include motion control configuration data 172. The motion control configuration data 172 may include settings and instructions related to controlling access to the applications 170. The motion control configuration data 172 may describe settings related to the access control such as which applications are motion-restricted, how to restrict access to those applications, a speed threshold at which each application is to be restricted, as well as other configuration settings. In some cases, the motion control configuration data 172 may include information relating to allowing the user to override the access control measures in emergency or other situations. For example, the user might have the option to select that they are on public transit and thus it is safe for them to use their mobile device. Or the user might have the option to select that they need to make an emergency call or send an email while driving. These override situations may be accompanied by additional measures that the user must perform in order to override the access control measures. For example, a user may be required to scan a QR code on a bus or subway to prove that they are actually on public transit and not operating a vehicle.

FIG. 2 illustrates an example environment 200 for implementing various features of a system capable of controlling application usage on a mobile device while the device is in motion. The illustrated environment 200 may include, or may be communicably coupled with, a mobile device 130, a plurality of global positioning satellites 180 and 182, and a configuration server 122. At least some of the communication between the illustrated systems, including between the mobile device 130, and the configuration server 122 may be performed across or via network 120. In general, environment 200 depicts an example configuration of a system for controlling application usage on a mobile device while the device is in motion.

The example environment 200 may also include GPS satellites 180 and 182. The mobile device 130 may use the GPS satellites 180 and 182 to calculate its speed of movement. Although two GPS satellites are pictured, some implementations include more GPS satellites. The mobile device 130 may include GPS receiver (as discussed relative to FIG. 1) that calculates its position by precisely timing the signals sent by GPS satellites 180 and 182. Each satellite continually transmits messages that include:
The time the message was transmitted
Precise orbital information (the ephemeris)
The general system health and rough orbits of all GPS satellites (the almanac)

The mobile device 130 may use the messages it receives to determine the transit time of each message and computes the distance to each satellite. These distances along with the satellites' locations are used with the possible aid of trilateration, depending on which algorithm is used, to compute the position of the mobile device 130. Because small clock errors in the signals from the GPS satellites 180 and 182 result in large positional errors, the mobile device 130 may use four or more satellites to solve for the device's location and time. Although four satellites are generally sufficient to provide an accurate positional reading, fewer satellites may be used in special cases. If one variable is already known, the mobile device 130 can determine its position using only three satellites. For example, a ship or aircraft may have known elevation. Some mobile devices may use additional clues or assumptions (such as reusing the last known altitude, dead reckoning, inertial navigation, or including information from the vehicle computer) to give a less accurate (degraded) position when fewer than four satellites are visible.

The mobile device 130 may be communicably coupled with a network 120 that facilitates wireless or wireline communications between the mobile device 130 and the configuration server 122, as well as with any other local or remote computer, such as additional clients, servers, or other devices communicably coupled to network 120, including those not illustrated in FIG. 2. In the illustrated environment, the network 120 is depicted as a single network, but may be comprised of more than one network without departing from the scope of this disclosure, so long as at least a portion of the network 120 may facilitate communications between senders and recipients. In some instances, one or more of the components associated with the system may be included within the network 120 as one or more cloud-based services or operations.

The network 120 may be all or a portion of an enterprise or secured network, while in another instance, at least a portion of the network 120 may represent a connection to the Internet. In some instances, a portion of the network 120 may include a portion of a cellular or mobile data network or other network capable of relaying short message service (SMS) or multimedia messaging service (MMS) messages, as well as other suitable mobile data messaging. In some instances, a portion of the network 120 may be a virtual private network (VPN). Further, all or a portion of the network 120 can comprise either a wireline or wireless link. Example wireless links may include 802.11a/b/g/n, 802.20, WiMax, 3G, 4G (i.e., LTE), and/or any other appropriate wireless link. In other words, the network 120 encompasses any internal or external network, networks, sub-network, or combination thereof operable to facilitate communications between various computing components inside and outside the illustrated environment 200. The network 120 may communicate, for example, Internet Protocol (IP) packets, Frame Relay frames, Asynchronous Transfer Mode (ATM) cells, voice, video, data, and other suitable information between network addresses. The network 120 may also include one or more local area networks (LANs), radio access networks (RANs), metropolitan area networks (MANs), wide area networks (WANs), all or a portion of the Internet, and/or any other communication system or systems at one or more locations.

In other implementations, the network 120 may provide the mobile device access to a positioning service capable of augmenting or replacing the GPS data from the GPS satellites 180 and 182. In such implementations, techniques such as multilateration of radio signals between several radio towers, or any other technique or combination of techniques, may be used to provide positioning data to the mobile device 130 via the network 120.

The mobile device 130 may also be coupled to a configuration server 122 via the network 120. The configuration server 122 may store configuration data related to controlling access to the applications on the mobile device 130. In some implementations, this configuration data may be a copy of or may replace motion control configuration data 172 depicted in FIG. 1. In other implementations, the configuration data may describe settings related to the access control such as which applications are motion-restricted, how to restrict access to those applications, a speed threshold at which each application is to be restricted, as well as other configuration settings. In some implementations, the configuration server may include a graphical user interface so the user or another user (such as an administrator or parent) may create, modify, or delete configuration settings. In some cases, this graphical user interface may include a web page that the user may access using a standard web browser.

FIG. 3 is a flowchart of an example method 300 for controlling application usage on a mobile device while the device is in motion. For clarity of presentation, the description that follows generally describes method 300 in the context of environments 100 and 200 illustrated in FIGS. 1 and 2. However, it will be understood that method 300 may be performed, for example, by any other suitable system, environment, or combination of systems and environments, as appropriate.

At 302, a request to access an application on a device is identified. In some cases the request to access the application may be a request to launch the application, such as by clicking on an icon on the home screen on the device. In other cases, the request to access the application may be an attempt to interact with an already running application, such as by providing keyboard input, tapping a portion of the screen, activating a hyperlink, speaking a voice command, or performing any other action meant to interact with the running application.

In other implementations, identifying a request to access the application may be omitted. In some cases, a running application might be disabled when the device reaches a speed threshold, regardless of if the user is requesting access to it or not. For example, if a video is playing on the device, playback of the video may be disabled when the device reaches a certain speed, regardless of if the user has interacted with the device or not.

At 304, it is determined whether the requested application is a motion-restricted application. This determination may be performed by consulting configuration data indicating whether the requested application is configured to be motion-restricted. In some implementations, this determination may include examining configuration data stored in a local memory of the device. In other implementations, this determination may include retrieving configuration data from an external source, such as a configuration server. If it is determined that the application is not motion-restricted, the method 300 continues to 306, and access to the requested application is allowed. If it is determined that the application is motion-restricted the method 300 continues to 308.

At 308, a speed of movement associated with the device is identified. This identification may include determining a first position of the device, a second position for the device at a later time, then comparing the two positions to determine the distance traveled in the time between the two readings. This distance may then be divided by the time between the two readings to compute the speed of movement of the device. In other cases, the speed of movement of the device is identified by utilizing multilateration of radio signals from multiple radio towers in a cellular telephone network. In other implementations, the device includes hardware or software capable of computing its current speed independent of external data. In other cases, the device may interface with another system within the device to acquire the speed of the device. In still other cases, the device may acquire its speed interfacing with systems external to, but co-located with the device. For example, in an implementation in which the device is embedded within a vehicle, the device may acquire the speed of the vehicle, and thus its own speed, from a speed tracking system associated with the vehicle such as a speedometer. The speed of movement of the device may be measured in any appropriate metric including, but not limited to, miles per hour, kilometers per hour, meters per second, feet per second, or any other metric or combination of metrics.

At 310, access to the application is controlled based at least in part on the identified speed of movement of the device. Controlling access may include restricting, prohibiting, allowing, or otherwise controlling access to applications on the device based on configuration data. In one implementation, an application's capability to use one or more subsystems of the device is controlled based on the identified speed. For example, in the case that the device is travelling faster than the configured threshold, the application may be restricted from receiving keyboard input, allowing it to only be accessed by voice. In another implementation, the wireless subsystem of the device may be disabled in response to an indication that the device is travelling faster than a speed threshold.

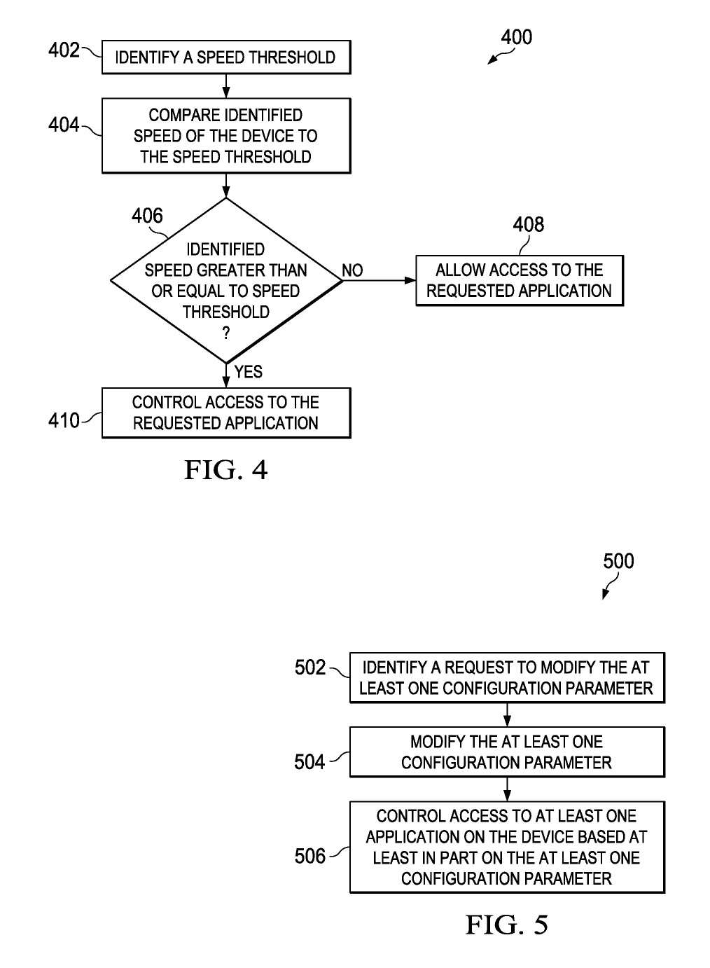

FIG. 4 is a flowchart of an example method 400 for determining whether an identified speed of the mobile device necessitates access control. For clarity of presentation, the description that follows generally describes method 400 in the context of environments 100 and 200 illustrated in FIGS. 1 and 2. However, it will be understood that method 400 may be performed, for example, by any other suitable system, environment, or combination of systems and environments, as appropriate.

At 402, a speed threshold is identified. In one implementation, this speed threshold is included within configuration data stored in the device's local memory. In another implementation the speed threshold is identified by querying an external configuration server. In another implementation, the speed threshold is identified based on a specific application associated with a request for access. For example, a texting application may have a different speed threshold than a less distracting application, such as a radio application or music application.

At 404, the identified speed of the device is compared to the speed threshold. This comparison may be a simple comparison, or additional calculation, rounding, or other actions may be performed. At 406, it is determined whether the identified speed is greater than or equal to speed threshold. In some implementations, 406 determines if the identified speed is greater than the threshold rather than greater than or equal to the threshold. If it is determined that the identified speed is less than the threshold, the method continues to 408, where access to the requested application is allowed. If it is determined that the identified speed is greater than or equal to the threshold, the method 400 continues to 410, where access to the requested application is controlled. In some implementations, this control is similar to that described at 310 in method 300, while in other implementations 410 differs from 310.

FIG. 5 is a flowchart of an example method 500 for configuring the motion control access restrictions. For clarity of presentation, the description that follows generally describes method 500 in the context of environments 100 and 200 illustrated in FIGS. 1 and 2. However, it will be understood that method 500 may be performed, for example, by any other suitable system, environment, or combination of systems and environments, as appropriate.

At 502, a request to modify the at least one configuration parameter is identified. In some implementations, the request to modify the configuration parameter is received via a graphical user interface associated with the device. In another implementation, the request to modify the configuration parameter is received on a web page associated with a configuration server storing configuration data. In another implementation, the request is received on the device but intended to modify data stored on a configuration server. In other cases, the request received is a programmatic request such as a function call or message generated by another electronic computing device.

At 504, the at least one configuration parameter is modified. In one implementation, the configuration parameter is modified by updating local memory on the device. In another implementation, the configuration parameter is modified by sending a message to a configuration server. In some cases, this message may be in the form of an HTTP SET request as part of a REST API. In another implementation, modifying the configuration parameter includes updating values in a database.

At 506, access to at least one application on the device is controlled based at least in part on the at least one configuration parameter. In some implementations, this control is similar to that described at 310 in method 300, while in other implementations 506 differs from 310.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program, by way of example, can be based on general or special purpose microprocessors or both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an API and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method executed by at least one processor, the method comprising:
identifying a request to access an application on a device;
determining if the requested application is a motion-restricted application;
upon determination that the requested application is a motion-restricted application, identifying a speed of movement associated with the device; and
controlling access to the requested application based at least in part on the identified speed of movement of the device.

2. The computer-implemented method of claim 1, further comprising:
upon determination that the requested application is not a motion-restricted application, allowing access to the requested application.

3. The computer implemented method of claim 1, wherein controlling access to the requested application based on the identified speed of movement of the device includes at least one of prohibiting access to the requested application, disabling a feature of the requested application, displaying a message stating that the requested application is motion-restricted, and allowing only hands-free access to the requested application.

4. The computer-implemented method of claim 1, wherein controlling access to the requested application based on the identified speed of movement of the device includes comparing the identified speed of movement of the device to a speed threshold and controlling access to the requested application if the identified speed of movement of the device exceeds the speed threshold.

5. The computer-implemented method of claim 1, wherein controlling access to the requested application is based at least in part on at least one configuration parameter, and wherein the computer-implemented method further comprises:
identifying a request to modify the at least one configuration parameter; and
modifying the at least one configuration parameter.

6. The computer-implemented method of claim 1, wherein identifying the speed of movement associated with the device includes utilizing a global positioning system.

7. The computer-implemented method of claim 1, wherein identifying the request to access the application on the device includes at least one of: receiving a request to launch the application, and receiving a request to access the application after the application has been launched.

8. The computer-implemented method of claim 1, further comprising:
allowing access to the requested application upon identifying a motion-restriction override request for the requested application.

9. A computer program product encoded on a tangible, non-transitory storage medium, the product comprising computer readable instructions for causing one or more processors to perform operations comprising:
identifying a request to access an application on a device;
determining if the requested application is a motion-restricted application;
upon determination that the requested application is a motion-restricted application, identifying a speed of movement associated with the device; and
controlling access to the requested application based at least in part on the identified speed of movement of the device.

10. The computer program product of claim 9, further comprising:
upon determination that the requested application is not a motion-restricted application, allowing access to the requested application.

11. The computer program product of claim 9, wherein controlling access to the requested application based on the identified speed of movement of the device includes at least one of prohibiting access to the requested application, disabling a feature of the requested application, displaying a message stating that the requested application is motion-restricted, and allowing only hands-free access to the requested application.

12. The computer program product of claim 9, wherein controlling access to the requested application based on the identified speed of movement of the device includes comparing the identified speed of movement of the device to a speed threshold and controlling access to the requested application if the identified speed of movement of the device exceeds the speed threshold.

13. The computer program product of claim 9, wherein controlling access to the requested application is based at least in part on at least one configuration parameter, and wherein the operations further comprise:
identifying a request to modify the at least one configuration parameter; and
modifying the at least one configuration parameter.

14. The computer program product of claim 9, wherein identifying the speed of movement associated with the device includes utilizing a global positioning system.

15. The computer program product of claim 9, wherein identifying the request to access the application on the device includes at least one of: receiving a request to launch the application, and receiving a request to access the application after the application has been launched.

16. The computer program product of claim 9, further comprising:
allowing access to the requested application upon identifying a motion-restriction override request for the requested application.

17. A system, comprising:
memory for storing data; and
one or more processors operable to:
identify a request to access an application on a device;
determine if the requested application is a motion-restricted application;
upon determination that the requested application is a motion-restricted application, identify a speed of movement associated with the device; and
control access to the requested application based at least in part on the identified speed of movement of the device.

18. The system of claim 17, wherein the one or more processors are further operable to:
upon determination that the requested application is not a motion-restricted application, allow access to the requested application.

19. The system of claim 17, wherein identifying the request to access the application on the device includes at least one of: receiving a request to launch the application, and receiving a request to access the application after the application has been launched.

20. The system of claim 17, wherein controlling access to the requested application based on the identified speed of movement of the device includes comparing the identified speed of movement of the device to a speed threshold and controlling access to the requested application if the identified speed of movement of the device exceeds the speed threshold.
